(19) United States
(12) Patent Application Publication
(10) Pub. No.: US 2009/0266218 A1
(43) Pub. Date: Oct. 29, 2009

(54) FOLDING ELECTRONIC PIANO COMPRISING KEYBOARD-STIFFENING MEANS

(76) Inventor: Raoul Parienti, Nice (FR)

Correspondence Address: JAMES C. LYDON, 100 DAINGERFIELD ROAD, SUITE 100, ALEXANDRIA, VA, 22314, US

(21) Appl. No.: 12/298,777

(22) PCT Filed: Apr. 28, 2006
(86) PCT No.: PCT/FR06/00963

§ 371 Date: Oct. 28, 2008

(51) Int. Cl. G10D 15/00; G10C 3/12

(52) U.S. Cl. 84/171; 84/423 R

(57) ABSTRACT

Foldable and portable electronic Piano composed of several modules (10, 12, 14, 16) constituted of a set of keys able to reproduce the notes of a piano thanks to its associated electronics, and including in addition <<stiffening>> means (that can provide stiffness), that can take two positions when the modules have been deployed to make a keyboard, a first position that allows to fold the keyboard and a second position providing the stiffness of the keyboard.

The present invention deals with electronic pianos and deals in particular with a foldable electronic piano with means to make the keyboard stiff.

A Piano is a music instrument with the characteristic of being very cumbersome and impossible to be carried by the pianist by opposition to most instruments, such as stringed instruments, that the player can easily carry around like a usual piece of luggage.

At present electronic keyboards are available that are easier to carry, but they are not foldable and hence are quite bulky when they have more than 5 octaves.

The keyboard of a foldable piano that is easily transportable is described in the European patent EP 0858649. The keyboard is composed of several modules linked together by a supple membrane, each module simulating a set of piano keys through a slightly raised design. This keyboard that can include up to seven octaves is of a book size when folded and it is an actual piano when unfolded, however the item presented in the present patent does not describe by any mean the ways to stiffen the keyboard.

In fact the keyboard described above needs to be laid on a stiff surface such as a table in order to make a stiff set so that the musician can play in the same fashion he would on an actual piano. Said differently, the keyboard does not include the means to make it stiff when the modules are deployed.

That is why the aim of the invention is to provide an electronic piano that is foldable and easy to carry and that includes means to stiffen the keyboard when unfolded.

U.S. Pat. No. 6,174,097 B1 mainly describes an electronic keyboard with means to lock the various modules of the keyboard but not to make it stiff.

The purpose of the invention is therefore a foldable and portable electronic piano composed of several modules constituted of a set of keys that can reproduce the notes of an actual piano thanks to its associated electronics, whose modules are linked together through a supple membrane that can withstand material working and allows the electronic piano to be folded and unfolded, the modules once folded being of the volume of a book and constituting the keyboard of an actual piano when unfolded. The piano includes in addition <<stiffening>> means (providing stiffness) that can be set in two positions once the modules have been deployed to make the keyboard, a first position allowing the keyboard to be folded and a second position making the keyboard stiff.

The aim, purpose and characteristics of the invention will appear more clearly when reading the description that follows with reference to the drawings:

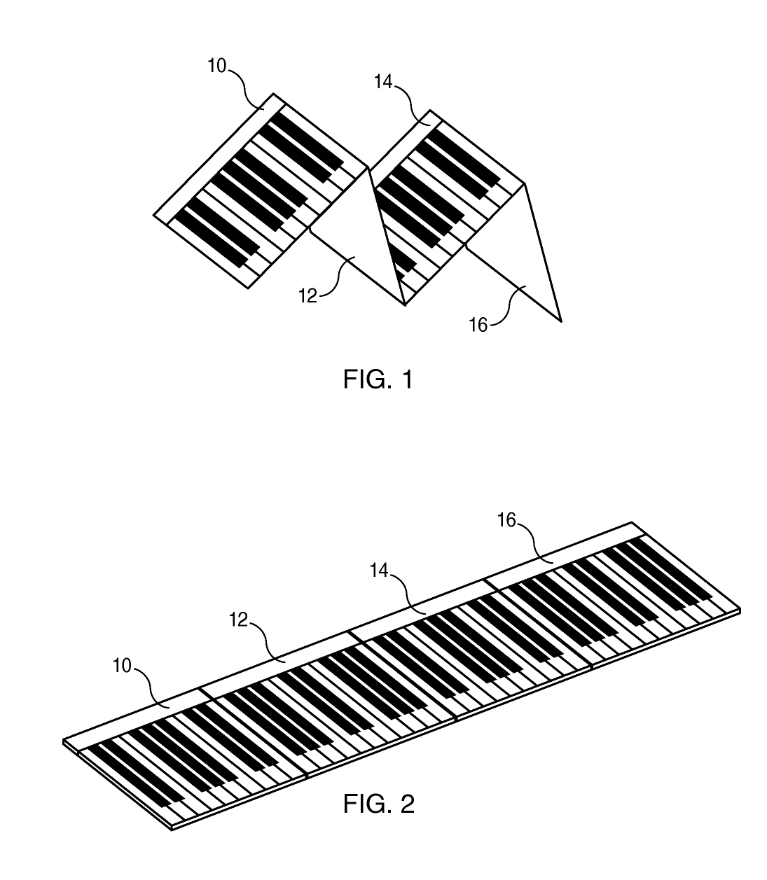

FIG. 1 shows the foldable piano according to the invention when it is unfolded,

FIG. 2 shows the piano of FIG. 1 completely unfolded and ready to be used by the pianist,

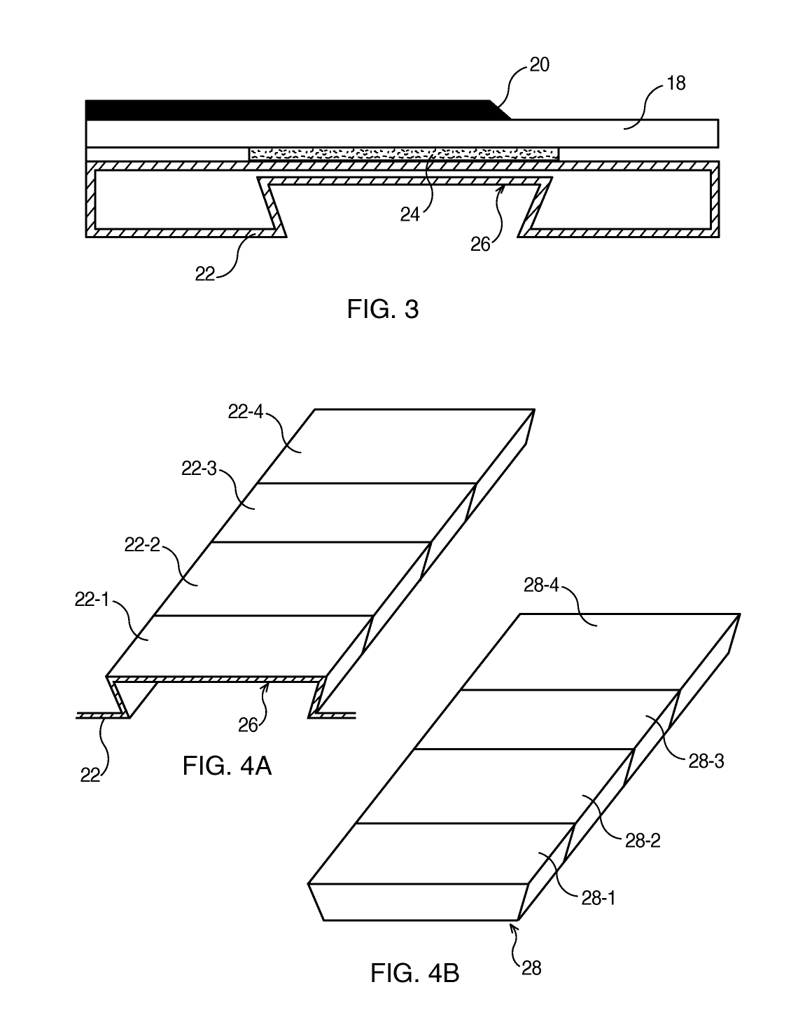

FIG. 3 is a cross section of the keyboard that shows the support of the keys that is suited to include the stiffening means according to the invention,

FIGS. 4A and 4B respectively show the dovetail female part of the keys support and the dovetail male part suited to slide into the female part,

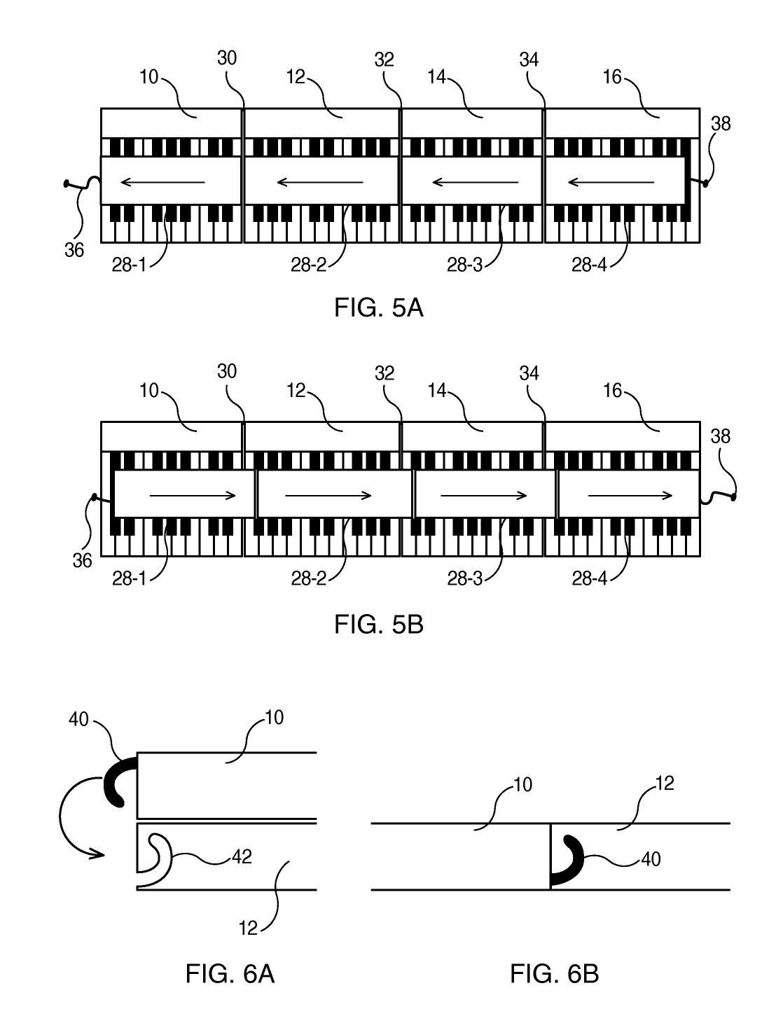

FIGS. 5A and 5B respectively show the keyboard of the foldable piano with the dovetail male part illustrated on FIG. 4B is in the position that allows the folding of the keyboard and in the position that stiffens the keyboard, and

FIGS. 6A and 6B show a schematic of two adjacent modules respectively in the folded position and in the unfolded position where a hook bound to one module is inserted in a hole in the other module.

A foldable piano that can exhibit the main inventive characteristic of this invention, i.e. the stiffening means, is described in the European patent EP 0858649. Such a piano is of course mainly composed of a keyboard. As illustrated on FIG. 1, it is constituted of 4 modules 10, 12, 14 and 16. However it could include more than 4 modules with shorter modules. It has to be noted that modules 12 and 16 have one more black key compared to modules 10 and 14 and therefore are longer.

The modules are linked together through a supple membrane that can withstand material working such as a rubber or latex membrane. When the keyboard is deployed and stiffened by the stiffening means described hereafter, it looks like illustrated on FIG. 2. It has to be noted that, thanks to the stiffening means, the user does not need to lay the keyboard on a stiff surface but he can put it on any support fitted for this use.

The contactors used to measure the touch of the keys may be ink, capacitive, resistive or piezoelectric contactors. The mere fact of pressing one finger on one key of the keyboard does not generate sound, the note sound being generated only when the key is hit. It has to be noted that with piezoelectric contactors, the variable mechanical energy induces a correlated current able to generate a large number of nuances.

Each hitting of a key generates a signal which is transmitted to a wired logic circuit controlled by a microprocessor (not shown) located in one of the modules. The electronic circuits are powered through batteries or power supply plug by means of a transformer. This way, the sounds to be reproduced are digitised sounds from an actual piano recorded in a memory chip. It has to be noted that the sounds may be reproduced thanks to a synthesizer that can also reproduce a large number of sounds from other music instruments.

With reference to FIG. 3, the full set of keys composed of white keys such as key 18 and of black keys such as key 20, is positioned on the support 22 made of stiff plastic material. One latex layer 24 is located between key 18 or 20 and the support 22 in order to damp the touch of the keys.

The keyboard support 22 includes one hollow dovetail piece or structure 26 illustrated on FIG. 4A. It has to be noted that, as shown on that figure, support 22 is actually made of 4 independent support parts 22-1, 22-2, 22-3 and 22-4 that respectively correspond to modules 10, 12, 14 and 16 and that have the same length as the said modules. A male dovetail structure 28 is associated to the female dovetail structure 22 as shown on FIG. 4B. Structure 28 made of stiff plastic material such as polycarbonate is adapted to fit and accurately slide into the female dovetail part 26. In the same way as for support 22, the male part 28 is constituted of 4 independent portions 28-1, 28-2, 28-3 and 28-4 that respectively correspond to the 4 keyboard modules. Two adjacent portions are connected together through flexible wires that allow the modules to be easily folded without damaging the connection between portions. Preferably, these wires are elastic so that adjacent portion are directly in contact when the keyboard has been deployed for use.

With reference to FIG. 5A which shows the keyboard that has been deployed, the 4 portions of the male dovetail part that are used for stiffening do not have the same length. Portions 28-1, 28-2 and 28-3 have a length equal respectively to the length of modules 10, 12, 14 and 16, but portion 28-4 has a length shorter to the length of module 16. In doing so, in the keyboard shown on FIG. 5A, portions 28-1, 28-2 and 28-3 are perfectly superimposed to modules 10, 12 and 14. The link (not shown) between portions 28-1 and 28-2 is positioned facing the supple membrane 30 linking modules 10 and 12, the link between portions 28-2 and 28-3 is positioned facing the supple membrane 32 linking modules 12 and 14, the link between portions 28-3 and 28-4 is positioned facing the supple membrane 34 linking modules 14 and 16. hence, in this configuration, the keyboard may be folded in order to be easily carried around.

A readily accessible string 36 is bound to the end of portion 28-1 of the stiffening structure, and the readily accessible string 38 is bound to the end of portion 28-4. In doing so, it is easy for the user who wants to fold the keyboard to grasp the string 36 in order to position the male stiffening structure in the position shown on FIG. 5A.

When the keyboard is unfolded, the user keeps it in the <<stiff position>> by pulling the string 38 so as to bring the male stiffening structure in the position shown on FIG. 5B, which means that the end of portion 28-4 is then positioned as superimposed on the outer edge of module 16. In doing so, the links between portions 28-1 and 28-2, 28-2 and 28-3, 28-3 and 28-4 are not superimposed anymore respectively to the supple membranes 30, 32 and 34, which hence prevents the folding of the keyboard.

It has to be noted that, due to the fact that the length of the portion of the male structure on the far right is smaller than the length of the corresponding module 16, the male structure 28 does not overhang on either end of the keyboard whether in the first position that allows folding or in the second position where the keyboard is stiffen.

If the keyboard has a number of modules different from four, for example n modules, the number of portions of the male adjacent structure whose length is equal to the length of the corresponding modules will be equal to n−1, only the nth portion being shorter than the module.

Due to the use of the supple membrane linking two adjacent modules, it might happen that the modules would not be properly aligned and as a result, there could be a gap between the keys of these two modules somewhat disturbing for the user, and also the male stiffening structure could not be moved as explained with reference to FIGS. 5A and 5B. In order to prevent this from happening, one can equip the modules with the mechanism described on FIGS. 6A and 6B. The left module, for instance module 10, includes one or two hooks such as hook 40, located on either side of the female stiffening structure. When the keyboard is deployed, the end of module 10 comes in direct contact with the end of the adjacent module 12. During this operation, hook 36 is introduced in hole 42 of module 12, which allows for a perfect adjustment of both modules. This set hook-hole also exists for modules 12 and 14 and also for modules 14 and 16.

According to another characteristic, the foldable piano according to the invention may include a pair of pedals that the user may connect when he wants to use the piano. When operated, the right pedal provides the usual pedal function for all pianos, i.e. to make the sound of the note or group of notes last longer. When activated, the left pedal may have the usual function of damping the played note or reproducing an innovative function which consists in amplifying the sound signal of the played notes. This application is useful when a non dynamic keyboard is used. These two connected pedals both include a stress gauge sensor for instance of the piezo-resistive type, which means that the pressure on such a sensor, induces a geometrical deformation which makes the characteristics of a resistor to vary.

The said variation of the resistance of the stress gauge sensor which is created by the foot pressure, transmits a correlated and calibrated analogue signal to an amplifier connected to the electronic circuits of the keyboard. As a result, the action of the left pedal induces variation of the notes volume that are played in order to simulate the nuances of the play. The higher the pressure on the pedal, the louder the volume of the notes will be played. This function may be inverted, so that the volume is at its maximum by default (fortissimo), and is gradually attenuated when the pressure on the pedal increases.

The mechanism of the pedals described above that uses stress gauge sensors may be integrated in a small volume with an oblong shape so that it can be inserted in one of the holes of the support 22 when the keyboard is folded (not shown).

In a more sophisticated version, the pedal mechanism described above is connected with the keyboard electronics via a short range wireless connection.

1-8. (canceled)

9. Foldable and portable electronic piano, comprising
several modules, each comprising a set of keys that can reproduce the music notes of an actual piano through its associated electronics, wherein said modules are linked together through a supple membrane capable of withstanding material working and which permits the electronic piano to be folded and unfolded, the modules once folded having the volume of a book and constituting the keyboard of an actual piano when they are deployed; and
stiffening means which can take two positions after the modules have been deployed to make a keyboard, a first position allowing the keyboard to be folded and a second position imparting stiffness to said keyboard.

10. The piano of claim 9, further comprising a keyboard support located below said modules, and which includes said stiffening means having a female structure formed by a part of said keyboard support and a male structure fitted to be positioned and slid into said female structure, said male structure comprising a number of stiff portions equal to the number of said modules and linked together by flexible wires so that, in said first position, the links between said portions accurately correspond to the supple membranes between said modules and, in said second position where said portions have been shifted, the links between said portions do not correspond anymore to said supple membranes, hence allowing stiffening of the keyboard.

11. The piano of claim 10, comprising n modules and whose said male structure comprises n−1 adjacent portions whose length is respectively equal to the length of corresponding modules and of one portion having a length shorter than a length of the corresponding module located at the end of said male structure so that in said first and second positions, said male structure does not overhang at each end of the keyboard.

12. The piano of claim 11, wherein each of the portions located at the end of said male structure includes a readily accessible string which allows the user, by pulling on one or the other of said strings, to move said male structure from said first position to said second position and vice versa.

13. The piano of claim 9, further comprising a plurality of pedals fitted with stress gauge sensors which under foot pressure transmit a calibrated and correlated analogue signal to an amplifier connected to said associated electronics of the keyboard in order to reproduce the effect of piano pedals.

14. The piano of claim 13, wherein said stress gauge sensors are piezo-resistive stress gauge sensors.

15. The piano of claim 9, further comprising a pedal fitted with a stress gauge sensor which under foot pressure transmits a calibrated and correlated analogue signal to an amplifier connected to said associated electronics of the keyboard in order to amplify the sound signal of the played notes, depending on the pressure on said pedal.

16. The piano of claim 15, wherein said stress gauge sensor is a piezo-resistive stress gauge sensor.

17. The piano of claim 13, wherein said stress gauge sensors transmit a calibrated and correlated analogue signal to said amplifier via a very short range wireless connection.

18. The piano of claim 13, wherein said pedals have a volume and oblong shape so that they can be slid into holes of said support when the keyboard is folded.
